(19) United States
(12) Patent Application Publication
(10) Pub. No.: US 2012/0114933 A1
(43) Pub. Date: May 10, 2012

(54) UV-CURING PROTECTIVE LAYER FOR THERMOPLASTIC SUBSTRATES

(75) Inventors: Birgit Meyer Zu Berstenhorst, Moers (DE); Frank Buckel, Kempen (DE)

(73) Assignee: Bayer MaterialScience AG, Leverkusen (DE)

(21) Appl. No.: 13/319,628

(22) PCT Filed: May 4, 2010
(86) PCT No.: PCT/EP2010/002700

§ 371 Date: Dec. 8, 2011

(30) Foreign Application Priority Data
May 12, 2009 (DE) 10 2009 020 934.4

(51) Int. Cl. B32B 5/16; B32B 27/00; C09D 175/14

(52) U.S. Cl. 428/331; 522/75; 428/500

(57) ABSTRACT

The invention relates to a multilayer product containing a first layer (S1) and a second layer (S2). The first layer is a lacquer obtained from A) one or more aliphatic polymer precursors selected from among at least one of the groups comprising components A.1 and A.2, wherein A.1) represents aliphatic oligomers that contain urethane or ester bonds and have at least two acrylate functions per molecule, or mixtures of corresponding oligomers, and A.2) represents aliphatic reactive diluents having at least two acrylate groups per molecule, or mixtures of corresponding reactive diluents, B) one or more fine-particle inorganic compounds, C) at least one organic UV absorber selected from among the group of triazine derivatives and diphenyl triazine derivatives, D) 0.1 to 2 wt. %, relative to the experimentally determined solid content of the mixture of components A, B, and F, of a radical interceptor belonging to the class of basic HALS, E) one or more optional self-leveling agents, F) one or more optional solvents, and G) at least one Norrish type II photoinitiator. The second layer is a thermoplastic polymer. The invention also relates to a lacquer made of the aforementioned components.

The present invention relates to a multilayer product, the first layer being a UV-cured protective layer which contains SiO₂ nanoparticles, and the second layer containing a thermoplastic substrate. The invention furthermore relates to the composition of the UV-curable first layer, to a method for producing the multilayer products and to products, for example glazing, which contain the said multilayer products.

C. Roscher in Pitture e Vernici—European Coatings 2004, 20, 7-10 discloses UV-curable organic coating composition systems containing nanoparticles of silicon dioxide as a coating system which has significantly improved scratch and abrasion resistance in comparison with corresponding filler-free coating composition systems.

Shaped bodies made of polycarbonate have already been known for a long time. Polycarbonate, however, has the disadvantage that it is not per se inherently UV-stable. The sensitivity curve of bisphenol A polycarbonate has the highest sensitivity between 320 nm and 330 nm. Below 300 nm no solar radiation reaches the Earth, and above 350 nm this polycarbonate is so insensitive that yellowing no longer takes place.

For permanent coating of a UV-sensitive plastic substrate, for example polycarbonate, i.e. for a multilayer product also suitable for long-term outdoor use, efficient UV protection is additionally required in the first layer.

Typical UV stabilisers which are known for their use in coatings are UV absorbers such as 2-hydroxybenzophenones, 2-(2-hydroxyphenyl)benzotriazoles, 2-(2-hydroxyphenyl)-1,3,5-triazines, 2-cyanoacrylates and oxalanilides, and radical scavengers of the HALS type (hindered amine light stabiliser). These additional coating components affect the radical crosslinking reaction started by UV light in a UV-curing binder, by competing for the UV light with the photoinitiator or by capturing the initiator or propagator radicals formed.

The prior art of multilayer products having a first layer consisting of an organic matrix which is formed by UV curing, is filled with nanoparticles and contains a UV absorber, will be summarised below.

EP-A 0 424 645 discloses a coating composition, curable by UV radiation, which is based on acrylates and colloidal silicon dioxide and in which UV absorbers, explicitly benzophenone, cyanoacrylate and benzotriazole types, and radical scavengers of the HALS type are mentioned as possible additives. With the use of UV light for radiation curing, the problem of hindering the cure as a function of the amount of UV absorber is indicated. With regard to the photoinitiator for the curing, according to EP-A 0 424 645 there are no restrictions; 2-hydroxy-2-methyl-1-phenylpropan-1-one (Darocure® 1173 from Ciba Speciality Chemicals) and 2,2-dimethoxy-1,2-diphenylethan-1-one (Irgacure® 651 from Ciba Speciality Chemicals) are explicitly mentioned.

EP-A 0 576 247 discloses a coating composition, curable by UV radiation, which is based on colloidal silicon oxide, silyl acrylate, acrylate, 2,4,6-trimethylbenzoyl-diphenylphosphine oxide (Lucirin TPO from BASF AG) as a photoinitiator and UV absorbers. Sterically hindered amines of the HALS type, fluoroacrylate and alkyl acrylate may optionally be used as additives. With Cyasorb® UV-416, Cyasorb® UV-531, Cyasorb® UV-5411, Tinuvin® 328 and Univol® 400, three types of benzophenone and two types of benzotriazole are explicitly mentioned as UV absorbers. Bis-(1,2,2,6,6-pentamethyl-4-piperidyl) (3,5-di-tert.-butyl-4-hydroxybenzyl)butylmalonate (Tinuvin® 144 from Ciba Speciality Chemicals) is not however mentioned.

It is furthermore known that Norrish Type II photoinitiators act as hydrogen abstractors. Amines can function as coinitiators. In this case, an ecxiplex (excited state) is formed from an excited Norrish Type II photoinitiator and a tertiary amine. Triethanolamine, for example, is customarily used as the tertiary amine. No indication of the use of a basic HALS system as an amine component could be found. (Chemistry & Technology of UV & EB Formulation for Coatings, Inks & Paints, Vol. III Photoinitiators for free radical and cationic polymerisation, K. Dietliker, SITA Technology Ltd, London 1991, 46-48 and 192-196).

In the literature [H. J. Hageman, Prog. Org. Coat. 1985, 13, 123-150] there is also an indication of reduced oxygen inhibition by the use of amines with aromatic ketones, which leads to more thorough curing and therefore better hardness.

In U.S. Pat. No. 5,468,789 discloses a coating composition, curable by UV radiation, which is based on colloidal silicon oxide, alkoxysilyl acrylate, acrylate monomer and a special yellowing inhibitor, and which may optionally include UV absorbers such as resorcinol monobenzoate and 2-methylresorcinol dibenzoate.

WO 2007/115678 describes a multilayer product consisting of a thermoplastic polymer and a UV-curing layer. The UV-curing layer contains aliphatic oligomers likewise containing urethane or ester bonds with at least two acrylate functions per molecule, or mixtures of corresponding oligomers, and reactive aliphatic diluents having at least two acrylate groups per molecule. Furthermore, one or more finely divided inorganic compounds, at least one organic UV absorber (preferably a diphenyltriazine derivative), one or more radical scavengers of the HALS class and at least one special photoinitiator selected from the group consisting of acylphosphine oxide derivatives and α-aminoalkylphenone derivatives. Unlike in this invention, benzophenone derivatives were not used as photoinitiators.

EP-A 824119 discloses a UV-curing coating composition based on an acrylic monomer, a photoinitiator, a UV absorber and silylacrylated silicon dioxide, a triazine likewise being explicitly mentioned. Only an acylphospine oxide is used as a photoinitiator.

In his article (Mechanisms of Thermal and Photodegradation of Bisphenol A Polycarbonate; Polymer Durability, Advances in Chemistry Series 249 (1996) 59-76), A. Factor describes the catalytic effect of bases, which leads to polycarbonate breakdown, for which reason in principle basic HALS is advised against in or on polycarbonate.

The systems commercially available to date still do not sufficiently satisfy the requirements, in particular for motor-vehicle glazing, where very low abrasion values are required. These are set out, for example, in the standards for plastic motor-vehicle glazing ECE R43 (2000) (Europe) and ANSI Z26.1-1996 (USA).

On the basis of the prior art, it was an object to provide a UV-curing coating composition based on polycarbonate, which has improved scratch resistance and weathering stability and shows little abrasion, for example in the Taber test. In particular, the coating composition should achieve less than 2% Δ haze in the Taber test (CS 10F wheels, type IV) 1000 cycles with 500 g load.

The object is achieved by a coating formulation containing at least one Norrish type II photoinitiator, preferably a benzophenone derivative, optionally in combination with a further photoinitiator selected from the group consisting of acylphosphine oxide derivatives and α-aminoalkylphenone derivatives, and from 0.1 to 2 wt. % of a radical scavenger of the basic HALS class, which after application and curing forms the first layer of the multilayer product.

The solution is surprising since it has generally been assumed that use of basic HALS should be avoided both owing to possible saponification of the polycarbonate and in combination with an acidic resin, and no synergy between basic HALS systems and Norrish type II photoinitiators has previously been known.

The invention therefore provides a multilayer product containing a first layer (S1) and a second layer (S2), wherein the first layer is a coating composition obtainable from
A) one or more aliphatic polymer precursors selected from at least one of the groups consisting of the components A.1 and A.2, where
   A.1) are aliphatic oligomers that contain urethane or ester bonds and have at least two acrylate functions per molecule, or mixtures of corresponding oligomers, and
   A.2) are reactive aliphatic diluents having at least two acrylate groups per molecule, or mixtures of corresponding reactive diluents,
B) one or more finely divided inorganic compounds,
C) at least one organic UV absorber selected from the group consisting of triazine derivatives and diphenyltriazine derivatives, preferably at least one diphenyltriazine derivative UV absorber,
D) from 0.1 to 2 wt. % of a radical scavenger of the basic HALS class, expressed in terms of the experimentally determined solids content of the mixture of components A, B, and F,
E) optionally one or more levelling agents,
F) optionally one or more solvents and
G) at least one Norrish type II photoinitiator, preferably a benzophenone derivative, optionally in combination with a further photoinitiator selected from the group consisting of acylphosphine oxide derivatives and α-aminoalkylphenone derivatives, which are preferably distinguished by a high photochemical reactivity and an absorption band in the near UV range >300 nm, particularly preferably λ>350 nm,
   and the second layer is a thermoplastic polymer.

In a preferred embodiment, the components of the first layer (S1) are used in the following quantitative proportions:

The following are used, expressed in terms of the mixture of components A and B:
from 20 to 95 wt. %, preferably from 50 to 80 wt. % of component A,
from 5 to 80 wt. %, preferably from 20 to 50 wt. % of component B and
from 0.1 to 10 wt. %, preferably from 0.5 to 8 wt. %, particularly preferably from 1 to 5 wt. % of component G.

The amount of solvent (component F) is set so that an experimentally determined solids content of from 20 to 50 wt. %, preferably 30-40 wt. % results for the mixture of components A, B and F.

The following are used, expressed in terms of the solids content of the mixture of components A, B and F:

from 0.1 to 20, preferably from 0.5 to 10, particularly preferably from 0.8 to 5 wt. % of component C,
from 0.1 to 2 wt. %, preferably 0.5-1.8 wt. %, particularly preferably from 0.6 to 1.5 wt. %, in particular 0.6-1.2 wt. % of component D and
from 0 to 5, preferably from 0.1 to 1 wt. % of component E.

### Components for Producing the First Layer (S1)

### Component A

The aliphatic polymer precursors according to component A are selected from at least one of the groups consisting of the components A.1 and A.2, where
A.1) are aliphatic oligomers that contain urethane or ester bonds and have at least two acrylate functions per molecule, or mixtures of corresponding oligomers, and
A.2) are reactive aliphatic diluents having at least two acrylate groups per molecule, or mixtures of corresponding reactive diluents.

Suitable polymer precursors according to component A having at least two acrylate groups per molecule are preferably those of the formula

(R¹₂C═CR²CO₂)ₙR³ (I)

where
n≧2,
R¹ and R² are independently of one another H or C₁ to C₃₀ alkyl, preferably H, methyl or ethyl and
R³ in the case of polymer precursors according to component A.1 is an n-valent organic residue which consists of aliphatic hydrocarbon units linked by urethane or ester bonds, or
R³ in the case of polymer precursors according to component A.2 is an n-valent organic residue, preferably having 1-30 carbon atoms.

The production of the suitable oligomers according to component A.1 which belong to the class of aliphatic urethane acrylates or polyester acrylates, respectively, and their use as coating binders are known and are described in Chemistry & Technology of UV & EB Formulation for Coatings, Inks & Paints, Vol. 2, 1991, SITA Technology, London (P. K. T. Oldring (Ed.) on pages 73-123 (Urethane Acrylates) or pages 123-135 (Polyester Aciylates).

The following are, for example, commercially available and suitable in the sense according to the invention here: aliphatic urethane acrylates such as Ebecryl® 4858, Ebecryl® 284, Ebecryl® 265, Ebecryl® 264 (manufacturer Cytec Surface Specialities in each case), Craynor® 925 from Cray Valley, Viaktin® 6160 from Vianova Resin, Desmolux® U 100 from Bayer MaterialScience AG, Photomer® 6891 from Cognis, or aliphatic urethane acrylates dissolved in reactive diluents, such as Laromer® 8987 (70% strength in hexanediol diacrylate) from BASF AG, Desmolux® U 680 H (80% strength in hexanediol diacrylate) from Bayer MaterialScience AG, Craynor® 945B85 (85% in hexanediol diacrylate) and Craynor® 963B80 (80% in hexanediol diacrylate) both from Cray Valley, or polyester acrylates such as Ebecryl® 810 or 830 from Cytec Surface Specialities.

The production and use of suitable reactive diluents according to component A.2 are known and are described in Chemistry & Technology of UV & EB Formulation for Coatings, Inks & Paints, Vol. 2, 1991, SITA Technology, London (P. K. T. Oldring (Ed.) on pages 237-306 (Reactive Diluents). Here, for example, the following are suitable in the sense according to the invention: methanediol diacrylate, 1,2-ethanediol diacrylate, 1,3-propanediol diacrylate, 1,2-propanediol diacrylate, glycerol triacrylate, 1,4-butanediol diacrylate, 1,3-butanediol diacrylate, 1,2,4-butanetriol triacrylate, 1,5-pentanediol diacrylate, neopentyl glycol diacrylate, pentaerythritol triacrylate, pentaerythritol tetraacrylate, 1,6-hexanediol diacrylate, trimethylolpropane diacrylate, trimethylolpropane triacrylate, tricyclodecane dimethanol diacrylate, diethylene glycol diacrylate, triethylene glycol diacrylate, tetraethylene glycol diacrylate, dipropylene glycol diacrylate, tripropylene glycol diacrylate, trimethylolpropane triethoxy triacrylate, dipentaerythritol pentaacrylate, dipentaerythritol hexaacrylate, ditrimethylolpropane tetraacrylate and the corresponding methacrylate derivatives. 1,6-Hexanediol diacrylate, tricyclodecane dimethanol diacrylate, trimethylolpropane triacrylate, pentaerythritol tetraacrylate and methacrylate derivatives thereof are preferably used. 1,6-Hexanediol diacrylate, tricyclodecane dimethanol diacrylate and methacrylate derivatives thereof are particularly preferably used, particularly in a mixture with component A.1.

### Component B

Component B comprises finely divided inorganic compounds, which preferably consist of at least one polar compound of one or more metals from main group 1 to 5 or subgroup 1 to 8 of the periodic table, preferably main group 2 to 5 or subgroup 4 to 8, particularly preferably main group 3 to 5 or subgroup 4 to 8, or of compounds of these metals with at least one element selected from oxygen, hydrogen, sulfur, phosphorus, boron, carbon, nitrogen or silicon.

Preferred compounds are for example oxides, hydroxides, hydrated oxides, sulfates, sulfites, sulfides, carbonates, carbides, nitrates, nitrites, nitrides, borates, silicates, phosphates, hydrides, phosphites or phosphonates.

The finely divided inorganic compounds preferably consist of oxides, phosphates, hydroxides, preferably TiO₂, SiO₂, SnO₂, ZnO, ZnS, ZrO₂, Al₂O₃, AlO(OH), bohmite, aluminium phosphates, and also TiN, WC, Fe₂O₃, iron oxides, Na₂SO₄, vanadium oxides, zinc borate, silicates such as Al silicates, Mg silicates, one-, two- or three-dimensional silicates. Mixtures and doped compounds may likewise be used.

Hydrated aluminium oxides (for example bohmite) and silicon dioxide are particularly preferred. Silicon dioxide is preferred in particular.

The finely divided inorganic compounds in the sense according to the invention have a average particle size (d₅₀ value) of from 1 to 200 nm, preferably from 5 to 50 nm, particularly preferably 7-40 nm. In particular, the finely divided inorganic compounds have a narrow particle size distribution with a ((d₉₀−d₁₀)/d₅₀) value for the distribution of less than or equal to 2, particularly preferably from 0.2 to 1.0. The determination of the particle size is carried out by analytical ultracentrifugation, d₉₀ being the 90% value, d₁₀ the 10% value and d₅₀ the average value of the integral mass distribution of the particle size. The use of analytical ultracentrifugation for particle size determination is described in H. G. Müller Progr. Colloid. Polym. Sci. 2004, 127, pages 9-13.

In a preferred embodiment, the surface of these finely divided inorganic compounds is modified with the aid of alkoxysilane compounds. To this end, alkoxysilane compounds of the formula are preferably used:

RₘSi(OR′)₄₋ₘ (II)

with
m=1, 2 or 3 and
R and R′=a monovalent organic residue, preferably an alkyl chain having from 1 to 30 carbon atoms.

The surface modification of the finely divided inorganic compounds is particularly preferably carried out with acrylate-functionalised trialkoxysilane compounds according to

(R¹₂C═CR²CO₂)—R⁴—Si(OR⁵)₃ (III)

where
R¹ and R² are independently of one another H or C₁ to C₃₀ alkyl, preferably H, methyl or ethyl,
R⁴ is a divalent organic residue, preferably an alkyl chain, having from 1 to 30 carbon atoms, and
R⁵ is monovalent organic residue, preferably an alkyl chain having from 1 to 30 carbon atoms, and particularly preferably methyl and ethyl.

The following acrylate-functionalised trialkoxysilane compounds are particularly preferably used for the surface modification of the finely divided inorganic compounds: (3-methacryloxypropyl)trimethoxysilane, (3-acryloxypropyl)-trimethoxysilane, (3-methacryloxypropyl)triethoxysilane, methacryloxymethyltriethoxysilane and methacryloxymethyltrimethoxysilane.

In a preferred embodiment, the finely divided inorganic compound is used as a dispersion in at least one component selected from the group consisting of A) and F). Finely divided inorganic compounds which can be dispersed agglomerate-free in the coating formulation are preferred.

### Component C

The UV absorbers in the sense according to the invention are derivatives of diphenyltriazine, benzotriazoles, oxalanilides or hydroxybenzophenone. Particularly preferred diphenyltriazines are those of the following Formula (IV):

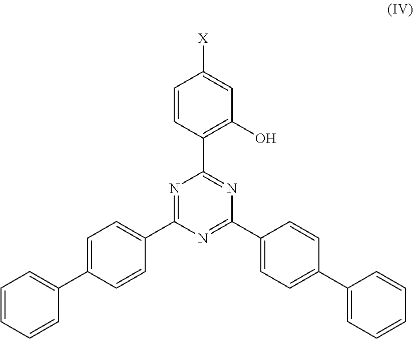

where
X═OR^{E}, OCH₂CH₂OR⁶, OCH₂CH(OH)CH₂OR⁶ or OCH(R⁷)COOR⁸, preferably OCH(R⁷)COOR⁸,
R⁶=branched or unbranched C₁-C₁₃ alkyl, C₂-C₂₀ alkenyl, C₆-C₁₂ aryl or —CO—C₁-C₁₈ alkyl,
R⁷═H or branched or unbranched C₁-C₈ alkyl, preferably CH₃, and
R⁸═C₁-C₁₂ alkyl; C₂-C₁₂ alkenyl or C₅-C₆ cycloalkyl, preferably C₈H₁₇.

A UV absorber according to Formula (IV) with X═OCH(R⁷)COOR⁸, R⁷═CH₃ and R⁸═C₈H₁₇ (UV absorber Tinuvin® 479 from the company Ciba Speciality Chemicals) is particularly preferably used as component C.

The diphenyl-substituted triazines of the general Formula (IV) are known in principle from WO-A 96/28431; DE-A 197 39 797; WO-A 00/66675; U.S. Pat. No. 6,225,384; U.S. Pat. No. 6,255,483; EP-A 1 308 084 and DE-A 101 35 795.

In a preferred embodiment, the UV absorbers have a high UV absorption in the greatest sensitivity range of the second layer, and the UV absorbers particularly preferably have a UV absorption maximum between 300-340 nm.

UV absorbers of the benzotriazole class are for example Tinuvin® 171 (2-[2-hydroxy-3-dodecyl-5-methylbenzyl]-phenyl)-2H-benztriazole (CAS No. 125304-04-3), Tinuvin® 234 (2-[2-hydroxy-3,5-di(1,1-dimethylbenzyl)phenyl]-2H-benztriazole (CAS No. 70321-86-7)), Tinuvin® 328 (2-2[hydroxy-3,5-di-tert.amyl-phenyl)-2H-benztriazole (CAS No. 25973-55-1).

UV absorbers of the oxalanilide class are for example Sanduvor® 3206 (N-(2-ethoxyphenyl)ethane diamide (CAS No. 82493-14-9)) from Clariant or N-(2-ethoxyphenyl)-N′-(4-dodecylphenyl)oxamide (CAS No. 79102-63-9).

UV absorbers of the hydroxybenzophenone class are for example Cimasorb 81 (2-benzoyl-5-octyloxyphenol (CAS No. 1843-05-6) from the company Ciba Speciality Chemicals, 2,4-dihydroxybenzophenone (CAS No. 131-56-6), 2-hydroxy-4-(n-octyloxy)benzophenone (CAS No. 1843-05-6), 2-hydroxy-4-dodecyloxybenzophenone (CAS No. 2985-59-3).

UV absorbers of the triazine class are for example 2-[2-hydroxy-4-(2-ethylhexyl)oxy]phenyl-4,6-di(4-phenyl)phenyl-1,3,5-triazine, 2-[2-hydroxy-4-[(octyloxycarbonyl)-ethylideneoxy]phenyl-4,6-di(4-phenyl)phenyl-1,3,5-triazine, 2-[2-hydroxy-4-[3-(2-ethylhexyl-1-oxy)-2-hydroxypropyloxy]phenyl]-4,6-bis(2,4-dimethylphenyl)-1,3,5-triazine (CAS No. 137658-79-8) also known as Tinuvin® 405 (Ciba Speciality Chemicals), 2,4-diphenyl-6-[2-hydroxy-4-(hexyloxy)phenyl]-1,3,5-triazine (CAS No. 147315-50-2) available as Tinuvin® 1577 (Ciba Speciality Chemicals). The compound 2-[2-hydroxy-4-(2-ethylhexyl)oxy]phenyl-4,6-di(4-phenyl)phenyl-1,3,5-triazine has the CAS No. 204848-45-3 and is available from Ciba Speciality Chemicals under the name Tinuvin® 479. The compound 2-[2-hydroxy-4-[(octyloxycarbonyl)ethylideneoxy]-phenyl-4,6-di(4-phenyl)phenyl-1,3,5-triazine has the CAS No. 204583-39-1 and is available from Ciba Speciality Chemicals under the name CGX-UVA006.

### Component D

Components D in the sense according to the invention are so-called HALS systems (hindered amine light stabiliser). The HALS system according to the present invention is an amine compound which is basic, generally has a pK_{b}<7, preferably ≦6.8, in particular ≦6 and is sterically hindered.

Basic HALS compounds have the general structure

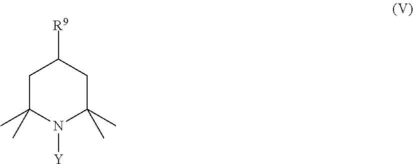

where

### Y═H or CH₃ and

### R⁹═Z—R¹⁰—Z—R¹¹,

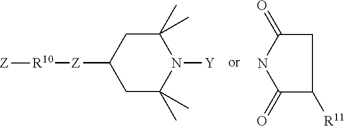

where
Z=a divalent functional group, for example and preferably C(O)O, NH or NHCO,
R¹⁰=a divalent organic residue, for example and preferably (CH₂)ₗ with l=1 to 12, preferably 3 to 10, C═CH-Ph-OCH₃,

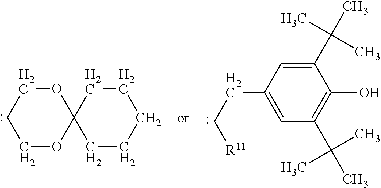

and
R¹¹ stands for H or C₁-C₂₀ alkyl.

Examples of HALS compounds are given with their pK_{b} in Table 1 below:

TABLE 1

| | | |
|---|---|---|
| 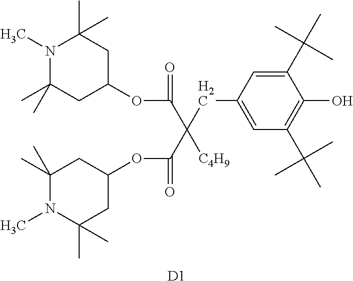 | Tinuvin ® 144 according to the invention | pK_{b}~5 |
| 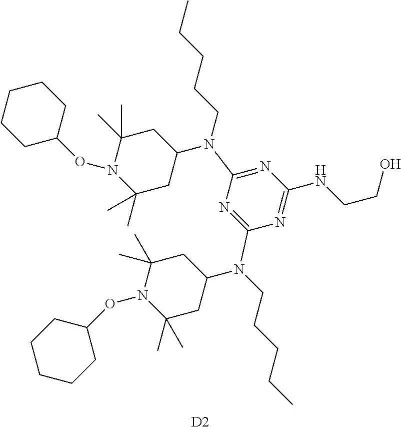 | Tinuvin ® 152 not according to the invention | pK_{b}~7 or 9.4 |
| 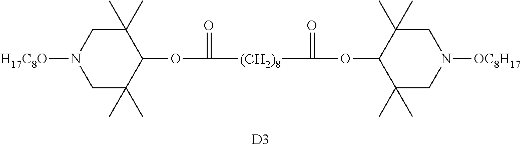 | Tinuvin ® 123 not according to the invention | pK_{b}~9.6 |
| 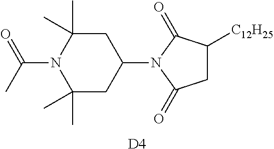 | Sanduvor ® 3058 not according to the invention | pK_{b} > 12 |

The pK_{b} values are taken from literature references for D3 and D4 and estimated therefrom for D1 (A. Valet: Lichtschutzmittel far Lacke [Photoprotectors for coating compositions], 1996, Curt R. Vincentz, Hannover). The information for D2 is given with the aid of the technical data sheet from Ciba Speciality Chemicals (March 2004).

Compound D1 is bis-(1,2,2,6,6-pentamethyl-4-piperidyl) (3,5-di-tert.-butyl-4-hydroxybenzyl)butylmalonate; Tinuvin® 144 (CAS No. 63843-89-0) from Ciba Speciality Chemicals. Compound D2 is 2,4-bis[(1-cyclohexyloxy-2,2,6,6-tetramethylpiperidin-4-yl)butylamino]-6-(2-hydroxyethylamino)-s-triazine, Tinuvin® 152 (CAS No. 150686-79-6) likewise from Ciba Speciality Chemicals. Compound D3 is bis(1-octyloxy-2,2,6,6-tetramethyl-4-piperidyl)sebacate, Tinuvin 123 (CAS No. 122586-52-1) from Ciba Speciality Chemicals. Compound D4 is N-(1-acetyl-2,2,6,6-tetramethyl-4-piperidinyl)-2-dodecylsuccinimide; Sanduvor® 3058 (CAS No. 106917-31-1) from Clariant. Furthermore, the mixture of bis(1,2,2,6,6-pentamethyl-4-piperidinyl) sebacate and 1-(methyl)-8-(1,2,2,6,6-pentamethyl-4-piperidinyl)sebacate of Formulae (D5) and (D6) is a preferred component D:

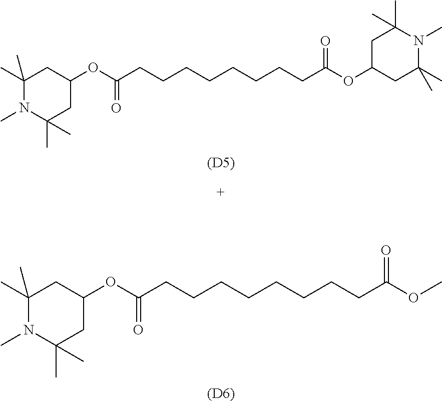

The mixture has a pK_{b} of ˜5 and is commercially available as Tinuvin® 292 from Ciba Speciality Chemicals (CAS No. 41556-26-7).

### Component E

Components E in the sense according to the invention are preferably all those levelling agents which allow both good wetting of the coating formulation on the surface of the second layer and a visually appealing surface of the first layer formed by curing the coating formulation. A review of conventional levelling agents is given by Janos Hajas “Leveling Additives” in Coatings, Johan Bieleman (Edt.), Wiley-VCH Verlag GmbH, Weinheim 2000, pages 164-179. For example and preferably, the levelling agent BYK® 300 from the company BYK Chemie is used.

### Component F

Components F in the sense according to the invention are solvents or solvent mixtures which must be compatible with the second layer to such an extent, and permit dispersion, application and deaeration of the coating formulation to such an extent, that a multilayer product with high transparency and low cloudiness is obtained after UV curing of the coating formulation to form the actual first layer. They may for example and preferably be alkanes, alcohols, esters, ketones or mixtures thereof. Alcohols (with the exception of methanol), ethyl acetate and butanone are particularly preferably used. Solvents or solvent mixtures selected from at least one of the group consisting of diacetone alcohol (CH₃)₂C(OH)CH₂C(═O)CH₃, ethyl acetate, methoxypropanol and butanone are more particularly preferred.

### Component G

Preferred Norrish type II photoinitiators in the sense of the present invention are benzophenone derivatives. With these, the radical formation takes place by hydrogen abstraction (cf.: H. J. Hageman, Prog. Org. Coat. 1985, 13, 123-150).

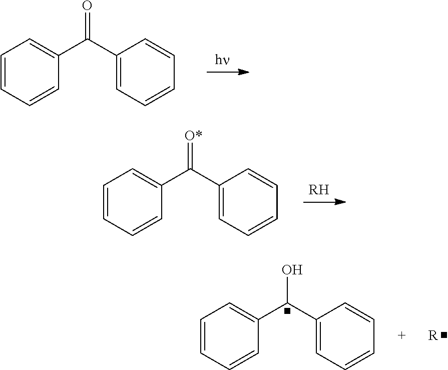

Particularly preferred photoinitiators G according to the present invention are selected from Norrish type II photoinitiators, such as benzophenone derivatives of Formula (GI):

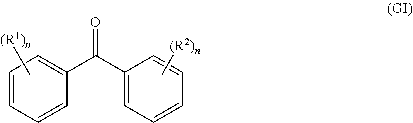

in which
R¹ and R² independently of one another respectively stand for C₁-C₆ alkyl, preferably C₁-C₄ alkyl, in particular methyl or ethyl
and
n independently of one another stand for 0, 1, 2 or 3, preferably for 0 or 1.

Further Norrish type II photoinitiators are mentioned in Chemistry & Technology of UV & EB Formulation for Coatings, Inks & Paints, Vol. 2, 1991, SITA Technology, London (P. K. T. Oldring (Ed.) on pages 288 to 294. Besides benzophenone derivatives, thioxanthone and 1,2-diketone derivatives also belong to this compound class.

Benzophenone derivatives of Formula (GI) may also be used in combination with 1-hydroxylcyclohexyl phenyl ketone derivatives of Formula (GII):

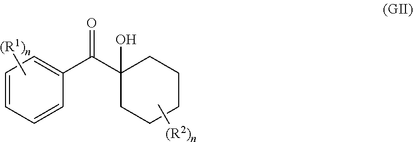

in which
R¹ and R² independently of one another respectively stand for C₁-C₆ alkyl, preferably C₁-C₄ alkyl, in particular methyl or ethyl
and
n independently of one another stand for 0, 1, 2 or 3, preferably for 0 or 1.

The compounds of Formulae (GI) and (GII) are preferably used in a weight ratio (GI):(GII) of from 70:30 to 30:70, particularly preferably from 60:40 to 40:60 and in particular from 55:45 to 45:55.

Particularly preferred are benzophenone (CAS No. 119-61-9) and 1-hydroxycyclohexyl phenyl ketone (CAS No. 947-19-3), available as a 1:1 mixture under the name Irgacure® 500 from Ciba Speciality Chemicals, i.e. the unsubstituted derivatives of Formulae (GI) and (GII).

As further photoinitiators, those of the Norrish type I may be used. Preferred ones are selected from the group consisting of acylphosphine oxide derivatives and α-aminoalkylphenone derivatives according to Formula V (acylphosphine oxides) and respectively VI (α-aminoalkylphenone),

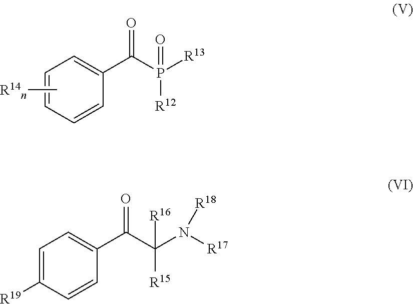

where
R¹²═C₁-C₃₀ alkyl; or C₅ to C₆ cycloalkyl, C₆ to C₂₀ aryl, C₆ to C₂₀ aryloxy or C₇ to C₁₂ aralkyl in each case optionally substituted by C₁ to C₄ alkyl and/or chlorine, bromine; preferably phenyl,
   CH₂CH(CH₃)CH₂C(CH₃)₃ or

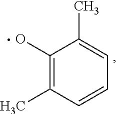

R¹³═C₁-C₃₀ alkyl, C₁-C₃₀ alkoxy; or C₅ to C₆ cycloalkyl, C₆ to C₂₀ aryl, C₆ to C₂₀ aryloxy, C₇ to C₂₁ aroyl or C₇ to C₁₂ aralkyl in each case optionally substituted by C₁ to C₄ alkyl, C₁ to C₄ alkoxy, C₁ to C₄ acyl and/or chlorine, bromine; preferably
OCH₂CH₃, phenyl,

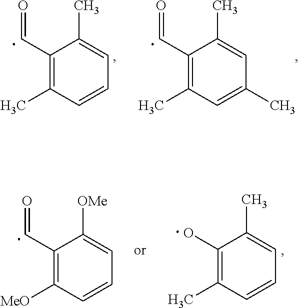

R¹⁴═C₁ to C₄ alkyl, C₁ to C₄ alkoxy, preferably CH₃ or OCH₃
n=0 to 5, preferably 0, 2 or 3,
R¹⁵, R¹⁶, R¹⁷ and R¹⁸ independently of one another respectively stand for C₁-C₃₀ alkyl; or C₅ to C₆ cycloalkyl, C₆ to C₂₀ aryl or C₇ to C₁₂ aralkyl in each case optionally substituted by C₁ to C₄ alkyl, and/or chlorine, bromine; preferably, R¹⁵ is CH₂Ph or CH₃, R¹⁶┘CH₂CH₃ or CH₃, R¹⁷═CH₃ and R¹⁸═CH₃,
   and where the residues R¹⁷ and R¹⁸ may also be linked to form a ring, so that the nitrogen N shown in Formula (VI) is part of a heterocyclic ring system,
   preferably part of morpholine

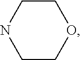

R¹⁹═C₁ to C₃₀ alkoxy, C₁ to C₃₀ alkylthio, C₁ to C₃₀ dialkylamino; or C₅ to C₆ cycloalkyl in each case optionally substituted by C₁ to C₄ alkyl, and/or chlorine, bromine, in which case the C atoms of the ring may also be substituted by heteroatoms such as N, O or S,
preferably methylthio or

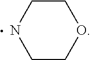

The following are preferably used as Norrish type I photoinitiators: bis(2,4,6-trimethylbenzoyl)phenyl-phosphine oxide (Irgacure® 819 from Ciba Speciality Chemicals), (2,4,6-trimethylbenzoyl)diphenylphosphine oxide (Lucirin® TPO Solid from BASF AG), bis(2,6-dimethylbenzoyl)(2,4,4-trimethylpentyl)phosphine oxide, bis(2,6-dimethoxybenzoyl)(2,4,4-trimethylpentyl)phosphine oxide, bis(2,6-dimethylphenyl)benzoylphosphonate (Lucirin® 8728 from BASF AG), 2,4,6-trimethylbenzoylethoxyphenyl-phosphine oxide (Lucirin® TPO-L from BASF AG), 2-benzyl-2-(dimethylamino)-1-(4-morpholinophenyl)-1-butanone (Irgacure® 369 from Ciba Speciality Chemicals) and 2-methyl-1-[4-(methylthio)phenyl]-2-morpholino-1-propanone (see Formula VIa; Irgacure® 907 from Ciba Speciality Chemicals).

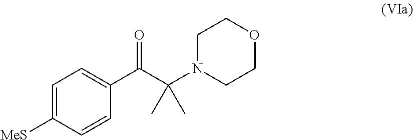

Bis(2,4,6-trimethylbenzoyl)phenylphosphine oxide (Irgacure® 819 from Ciba Speciality Chemicals), 2,4,6-trimethylbenzoylethoxyphenylphosphine oxide (Lucirin® TPO-L from BASF AG) and 2-methyl-1-[4-(methylthio)phenyl]-2-morpholino-1-propanone (Irgacure® 907 from Ciba Speciality Chemicals) are particularly preferably used.

The photoinitiators of Formulae (GI) or (GI) and (GII) may respectively be used separately or as a mixture, or as a mixture with the photoinitiators of Formulae (V) and (VI).

Photoinitiators (V) and/or (VI) are preferably used in an amount of from 10 to 35 wt. %, particularly preferably from 15 to 30 wt. %, in particular from 18 to 25 wt. % (expressed in terms of a 100 wt. % amount of photoinitiators (G).

### Production of the Second Layer (S2)

Thermoplastic polymers of the second layer in the sense according to the invention are polycarbonate, polyester carbonate, polyester (for example polyalkylene terephthalate), polymethyl methacrylate, polyphenylene ether, graft copolymers (for example ABS) and mixtures thereof.

The second layer is preferably polycarbonate, in particular homopolycarbonate, copolycarbonate and/or thermoplastic polyester carbonate.

They preferably have an average molecular weight M̅ w of from 18,000 to 40,000, preferably from 22,000 to 36,000 and in particular from 24,000 to 33,000, determined by measuring the relative solution viscosity in dichloromethane or in mixtures of equal amounts of phenol/o-dichlorobenzene by weight calibrated by light scattering.

To the polycarbonate according to the invention and the optionally further contained [lacuna]-stabilisers, thermostabilisers, antistatics and pigments may be added in the conventional amounts; optionally, the mould release and/or the rheology may also be improved by adding external mould release agents and/or flow control agents (for example alkyl and aryl phosphites, phosphates, phosphanes, low molecular weight carboxylates, halogen compounds, salts, chalk, ground quartz, glass and carbon fibres, pigments and combinations thereof). Such compounds are described for example in WO 99/55772, pages 15-25, EP 1 308 084 and in the corresponding chapters of the “Plastics Additives Handbook”, ed. Hans Zweifel, 5^{th} Edition 2000, Hanser Publishers, Munich.

With respect to the production of polycarbonates, reference may be made for example to WO 2004/063249 A1, WO 2001/05866 A1, WO 2000/105867, U.S. Pat. No. 5,340,905, U.S. Pat. No. 5,097,002, U.S. Pat. No. 5,717,057 and the literature cited therein.

The polycarbonates are preferably produced by the phase interface method or the melt transesterification method, and will be described below with reference to the phase interface method by way of example.

Compounds preferably used as starting compounds are bisphenols of the general Formula (VII):

HO—R—OH (VII),

wherein R is a divalent organic residue having from 6 to 30 carbon atoms, which contains one or more aromatic groups.

Examples of such compounds are bisphenols which belong to the group consisting of dihydroxydiphenyls, bis(hydroxyphenyl)alkanes, indane bisphenols, bis(hydroxyphenyl)ethers, bis(hydroxyphenyl)sulfones, bis(hydroxyphenyl)ketones and α,α′-bis(hydroxyphenyl)diisopropylbenzenes.

Particularly preferred bisphenols which belong to the aforementioned compound groups are bisphenol A, tetraalkylbisphenol A, 4,4-(meta-phenylenediisopropyl)-diphenol (bisphenol M), 4,4-(para-phenylenediisopropyl)diphenol, 1,1-bis-(4-hydroxyphenyl)-3,3,5-trimethylcyclohexane (BP-TMC) and optionally mixtures thereof.

The bisphenol compounds to be used according to the invention are preferably reacted with carbonic acid compounds, in particular phosgene, or in the melt transesterification process with diphenyl carbonate or dimethyl carbonate.

Polyester carbonates are preferably obtained by reacting the aforementioned bisphenols, at least one aromatic dicarboxylic acid and optionally carbonic acid equivalents. Suitable aromatic dicarboxylic acids are for example phthalic acid, terephthalic acid, isophthalic acid, 3,3′- or 4,4′-diphenyldicarboxylic acid and benzophenone dicarboxylic acids. A fraction of up to 80 mol. %, preferably from 20 to 50 mol. % of the carbonate groups in the polycarbonates may be replaced by aromatic dicarboxylate groups.

Inert organic solvents used in the phase interface method are for example dichloromethane, the various dichloroethanes and chloropropane compounds, tetrachloromethane, trichloromethane, chlorobenzene and chlorotoluene; chlorobenzene or dichloromethane or mixtures of dichloromethane and chlorobenzene are preferably used.

The phase interface reaction may be accelerated by catalysts such as tertiary amines, in particular N-alkylpiperidines or onium salts. Tributylamine, triethylamine and N-ethylpiperidine are preferably used. In the case of the melt transesterification process, the catalysts mentioned in DE-A 4 238 123 are preferably used.

The polycarbonates can be branched in a deliberate and controlled way by using small amounts of branching agents. Some suitable branching agents are: phloroglucinol, 4,6-dimethyl-2,4,6-tri-(4-hydroxyphenyl)-heptene-2; 4,6-dimethyl-2,4,6-tri-(4-hydroxyphenyl)heptane; 1,3,5-tri-(4-hydroxyphenyl)benzene; 1,1,1-tri-(4-hydroxyphenyl)ethane; tri-(4-hydroxyphenyl)phenylmethane; 2,2-bis-[4,4-bis-(4-hydroxyphenyl)-cyclohexyl]propane; 2,4-bis-(4-hydroxyphenyl-isopropyl)phenol; 2,6-bis-(2-hydroxy-5′-methyl-benzyl)-4-methylphenol; 2-(4-hydroxyphenyl)-2-(2,4-dihydroxyphenyl)propane; hexa-(4-(4-hydroxyphenyl-isopropyl)-phenyl) orthoterephthalate; tetra-(4-hydroxyphenyl)methane; tetra-(4-(4-hydroxyphenyl-isopropyl)-phenoxy)methane; α,α,‘α′’-tris-(4-hydroxyphenyl)-1,3,5-triisopropylbenzene; 2,4-dihydroxybenzoate; trimesic acid; cyanuric chloride; 3,3-bis-(3-methyl-4-hydroxyphenyl)-2-oxo-2,3-dihydroindole; 1,4-bis-(4′,4″-dihydroxytriphenyl)-methyl)benzene and, in particular: 1,1,1-tri-(4-hydroxyphenyl)-ethane and bis-(3-methyl-4-hydroxyphenyl)-2-oxo-2,3-dihydroindole.

The 0.05 to 2 mol. % of branching agents or mixtures of branching agents optionally also to be used, expressed in terms of the diphenols used, may be used together with the diphenols or, alternatively, added at a later stage in the synthesis.

As chain terminators, it is preferable to use phenols such as phenol, alkylphenols such as cresol and 4-tert.-butylphenol, chlorophenol, bromophenol, cumylphenol or mixtures thereof in amounts of 1-20 mol. %, preferably 2-10 mol. % per mole of bisphenol. Phenol, 4-tert.-butylphenol or cumylphenol are preferred.

Chain terminators and branching agents may be added separately to the syntheses, or alternatively together with the bisphenol.

Production of the polycarbonates by the melt transesterification process is described, for example, in DE-A 4238 123.

Polycarbonates preferred according to the invention for the second layer of the multilayer product according to the invention are the homopolycarbonate based on bisphenol A, the homopolycarbonate based on based on 1,1-bis-(4-hydroxyphenyl)-3,3,5-trimethylcyclohexane and the copolycarbonates based on the two monomers bisphenol A and 1,1-bis-(4-hydroxyphenyl)-3,3,5-trimethylcyclohexane.

The homopolycarbonate based on bisphenol A is particularly preferred.

The polycarbonate may contain stabilisers. Suitable stabilisers are for example phosphines, phosphites or stabilisers containing Si, and other compounds described in EP-A 0 500 496. Triphenylphosphites, diphenylalkylphosphites, phenyldialkyl-phosphites, tris-(nonylphenyl)phosphite, tetrakis-(2,4-di-tert.-butylphenyl)-4,4′-diphenylene diphosphonite and triarylphosphite may be mentioned by way of example. Triphenylphosphine and tris-(2,4-di-tert.-butylphenyl)phosphite are particularly preferred.

The second layer of the multilayer product according to the invention, containing the polycarbonate, may furthermore contain from 0.01 to 0.5 wt. % of the esters or semiesters of mono- to hexavalent alcohols, in particular of glycerol, pentaerythritol or Guerbet alcohols.

Examples of monovalent alcohols are stearyl alcohol, palmityl alcohol and Guerbet alcohols.

An example of a divalent alcohol is glycol.

An example of a trivalent alcohol is gylcerol.

Examples of tetravalent alcohols are pentaerythritol and mesoerythritol.

Examples of pentavalent alcohols are arabitol, ribitol and xylitol.

Examples of hexavalent alcohols are mannitol, glucitol (sorbitol) and dulcitol.

The esters are preferably the monoesters, diesters, triesters, tetraesters, pentaesters and hexaesters, or mixtures thereof, in particular statistical mixtures, of saturated aliphatic C₁₀ to C₃₆ monocarboxylic acids and optionally hydroxy-monocarboxylic acids, preferably with saturated aliphatic C₁₄ to C₃₂ monocarboxylic acids and optionally hydroxy-monocarboxylic acids.

The commercially available fatty acid esters, in particular of pentaerythritol and glycerol, may contain <60% of various semiesters owing to production.

Examples of saturated aliphatic monocarboxylic acids having from 10 to 36 C atoms are capric acid, lauric acid, myristic acid, palmitic acid, stearic acid, hydroxystearic acid, arachidic acid, behenic acid, lignoceric acid, cerotic acid and montanic acid.

Examples of preferred saturated aliphatic monocarboxylic acids having from 14 to 22 C atoms are myristic acid, palmitic acid, stearic acid, hydroxystearic acid, arachidic acid and behenic acid.

Saturated aliphatic monocarboxylic acids such as palmitic acid, stearic acid and hydroxystearic acid are particularly preferred.

The saturated aliphatic C₁₀ to C₃₆ carboxylic acids and the fatty acid esters per se are either known from the literature or can be produced by methods known from the literature. Examples of pentaerythritol fatty acid esters are those of the particularly preferred monocarboxylic acids mentioned above. Esters of pentaerythritol and of glycerol with stearic acid and palmitic acid are particularly preferred. Esters of Guerbet alcohols and of glycerol with stearic acid and palmitic acid, and optionally hydroxystearic acid, are also particularly preferred.

The multilayer product according to the invention may comprise further layers, in particular a further UV protection layer (S3) which contains a UV stabiliser according to Formula (IV). The layer sequence is in this case (S1)-(S2)-(S3), and the layers (S1) and (S3) may have identical or different compositions.

The multilayer product according to the invention, or the thermoplastic polymers used for production, may contain organic dyes, inorganic colour pigments, fluorescent dyes and particularly preferably optical brighteners.

The invention also provides a coating composition obtainable from
A) one or more aliphatic polymer precursors selected from at least one of the groups consisting of the components A.1 and A.2, wherein
   A.1) are aliphatic oligomers that contain urethane or ester bonds and have at least two acrylate functions per molecule, or mixtures of corresponding oligomers, and
   A.2) are reactive aliphatic diluents having at least two acrylate groups per molecule, or mixtures of corresponding reactive diluents,
B) one or more finely divided inorganic compounds,
C) at least one organic UV absorber selected from the group consisting of triazine derivatives and diphenyltriazine derivatives, preferably at least one diphenyltriazine derivative UV absorber,
D) from 0.1 to 2 wt. % of a radical scavenger of the basic HALS class, expressed in terms of the experimentally determined solids content of the mixture,
E) optionally one or more levelling agents,
F) optionally one or more solvents, and
G) at least one Norrish type II photoinitiator, optionally in combination with a further photoinitiator selected from the group consisting of acylphosphine oxide derivatives and α-aminoalkylphenone derivatives, which are preferably distinguished by a high photochemical reactivity and an absorption band in the near UV range >300 nm, particularly preferably λ>350 nm,
   which is suitable for the production of at least one layer of a multilayer product.

The invention also provides a method for producing a multilayer product, wherein
(i) in a first step, the first layer S1 is applied in the form of a coating formulation onto the second layer S2, which is preferably a shaped plastic part of arbitrary configuration produced from the thermoplastic polymer according to S2 by means of injection moulding or extrusion, and
(ii) in a second step, the coating formulation of the first layer is cured.

Preferably, in the first step (i), the coating formulation is applied onto the surface of the second layer by flow coating, dip coating, spraying, rolling or spin coating, and subsequently deaerated at room temperature and/or elevated temperature (preferably at 20-200° C., particularly preferably at 40-120° C.). The surface of the second layer may be pretreated by cleaning or activation.

Preferably, in the second step (ii), the curing of the first layer is carried out by means of UV light, an iron-doped mercury vapour lamp or a pure mercury vapour lamp, or one doped with gallium, preferably being used as the UV light source.

The invention furthermore provides the production of the multilayer products and the products made from the multilayer products. The present invention also provides the use of the said multilayer products, in particular for outdoor applications with high long-term requirements in relation to visual impression, for example glazing.

The invention also provides in particular multilayer products which contain a shaped plastic part as layer S2, which is preferably produced from thermoplastic polymer by means of injection moulding or extrusion, and are coated with the coating composition according to S1 and optionally also with a further layer S3. For example, this multilayer product constitutes glazing, for example architectural glazing, motor-vehicle glazing, headlight lenses, spectacles or helmet visors.

### EXAMPLES

Component A: Laromer® 8987, an aliphatic urethane triacrylate having 30% of 1,6-hexanediol diacrylate as reactive diluent from BASF AG
Component AB:
Component AB 1: Nanocryl® xp21/1447 (nanoresins AG); Laromer® 8987, an aliphatic urethane triacrylate having 30% of 1,6-hexanediol diacrylate as reactive diluent from BASF AG, and a solids content of 40 wt. % finely divided SiO₂ (d₅₀ value=24.1 nm; (d₉₀−d₁₀)/d₅₀ value=0.49).
Component C: UV absorber Tinuvin® 479 from the company Ciba Speciality Chemicals.
Component D:
Component D-1: HALS system Tinuvinv® 144 from the company Ciba Speciality Chemicals. (According to the invention).
Component D-2: HALS system Tinuvin® 152 from the company Ciba Speciality Chemicals.
Component D-3: HALS system Tinuvin® 123 from the company Ciba Speciality Chemicals.
Component D-4: HALS system Sanduvor® 3058 from the company Clariant.
Component E: levelling agent BYK® 300 from the company BYK Chemie
Component F: diacetone alcohol
Component G:
Component G-1: Irgacure® 184 from the company Ciba Speciality Chemicals (comparison)
Component G-2: Irgacure® 500 from the company Ciba Speciality Chemicals
Component G-3: Irgacure® 1800 from the company Ciba Speciality Chemicals (comparison)
Component G-4: Lucirin® TPO-L from the company BASF AG

### Experimental Method (General Description):

### a) Production of the Coating Formulation:

The amounts of the said type of the component AB, indicated in Table 2 in the columns “basic coating formulation”, from the company nanoresins AG were dissolved in the indicated amounts of component F. The solids content was then experimentally determined with the aid of the MA40 solids tester from the company Satorius, as described below.

Experimental determination of the solids content with the MA40 solids tester from the company Satorius:

An amount of about 2 g of the prepared coating solution is placed in an aluminium dish and the exact weight m(initial weight before the heating phase) is determined. The coating solution is subsequently heated to 105° C. and maintained at 105° C. until constant weight. After constant weight has been reached, the weight m(final weight at constant weight) is read. The ratio of m(final weight at constant weight) to m(initial weight before the heating phase) gives the experimentally determined solids.

The solids content of the amount of component AB used is determined in the same way, but without prior dilution by component F.

The following are successively added while stirring and fully dissolved to the amount of coating solution reduced by the amount taken for the solids determination:

2.2 wt. % (expressed in terms of the experimentally determined solids content) of component C,
1 or 2 or an amount more than 2 wt. % (expressed in terms of the experimentally determined solids content of AB and F) of component D (see Table 2 column “UV stabiliser package”), more than 2 wt. % representing the greatest soluble amount and the unresolved part of component D being separated by filtration,
5 wt. % (expressed in terms of the experimentally determined solids content of the amount of component AB used) of component G, the type and composition for mixtures being given in Table 2, and
0.5 wt. % (expressed in terms of the coating solution consisting of components AB and F) of component E.
   b) Coating of the Substrates with the UV-Curing Coating Formulation:

The injection-moulded polycarbonate (PC) plates used, in optical quality made of Makrolon® AL 2647 (Bayer MaterialScience AG; medium-viscosity bisphenol A polycarbonate, MVR 12.5 cm³/10 min according to ISO 1133 at 300° C. and 1.2 kg, with UV stabilisation, easily demoulded) of size 10×15×0.32 cm, were heat-treated for 1 h at 120° C., washed with isopropanol, deaerated, UV-pretreated (with a KTR 2061 laboratory UV radiator from the company Hackemack; belt speed 3 m/min and with a UV dose (Hg lamp) of 1.6 J/cm², measured with an eta plus UMD-1 dosimeter) and then treated with ionised air. The UV-curing coating composition from a) was then applied by the flow coating method. The coated plates were deaerated for 30 min at room temperature, then dried at 110° C. for 30 min and cooled again to room temperature. They were then cured once with a belt speed of 1.2 m/min in a KTR 2061 laboratory UV radiator from the company Hackemack and with a UV dose (Fe lamp) of 9.6 J/cm², measured with an eta plus UMD-1 dosimeter.

### c) Study of the Adhesion of the UV-Curing Protective Layer on the PC Substrate:

The following adhesion tests were carried out:
(a) adhesive tape peel (adhesive tape used 3M Scotch 898) without and with lattice cut (similar to ISO 2409 or ASTM D 3359), and
(b) adhesive tape peel after 10 days of storage in warm water at about 65° C. (similar to ISO 2812-2 and ASTM 870-02).

All the examples noted here show full adhesion (ISO parameters: 0 or ASTM parameters: 5B) both after (a) and after (b).

### d) Measurement of the Abrasion Resistance and Determination of the Taber Value:

First, the initial phase value of the PC plate coated with the UV-cured first layer (obtained from c)) was determined according to ASTM D 1003 with a Haze Gard Plus from the company Byk-Gardner. Subsequently, the coated side of the specimen was scratched by using a model 5131 Taber Abraser from the company Erichsen according to ISO 52347 or ASTM D 1044, using the CS10F wheels (type IV; grey colour). By determining the final haze value after 1000 rotations with a 500 g load, a Δhaze value (specimen) could be determined.

In the sense according to the invention, the first layer should have a sufficiently high scratch resistance. This criterion is achieved in the sense according to the invention when the Taber value is less than or equal to two.

### Results:

TABLE 2
Basic Formulation of UV-Curing Coating Composition:

| | | NB | | | |
|---|---|---|---|---|---|
| | | wt. % data | | | |
| Substance | | expressed in | | wt. | |
| used | Substance class | terms of | g | % | n (mmol) |
| diacetone | solvent | | 14.70 | | |
| alcohol | | | | | |
| F-1 | | | | | |
| Nanocryl | polyurethane | | 10.20 | | |
| xp21/1447 | acrylate (resin) | | | | |
| (AB-1) | containing | | | | |
| | nanoparticles | | | | |
| Lucirin | photoinitiator | solids | 0.094 | 1.0 | |
| TPO-L | | content of | | | |
| (G-4) | | comp. | | | |
| | | AB-1 | | | |
| Irgacure | photoinitiator | solids | 0.376 | 4.0 | benzophenone |
| 500 | | content of | | | content: |
| (G-1) | | comp. | | | 0.488 |
| | | AB-1 | | | |
| BYK 300 | levelling agent | Total coating | 0.115 | 0.5 | |
| (E) | | composition: | | | |
| | | AB + F | | | |
| Tinuvin ® | UV absorber | solids | 0.176 | 2.2 | |
| 479 | | content | | | |
| (C) | | AB + F | | | |
| Tinuvin ® | Basic HALS | solids | 0.080 | 1.0 | 0.117 |
| 144 (D-2) | (radical | content | | | |
| | scavenger) | AB + F | | | |

### Effect of Nanoparticles:

TABLE 3

| | | | | Taber_{(1000 cycles,500 g,CS10F wheels)} |
|---|---|---|---|---|
| Ex. | Binder resin | HALS | Photoinitiator | Δ haze (%) |
| 1 C | Laromer 8987 | 1% Tinuvin ® | 4% Irgacure ® 500, | 38 |
| | (comp. A) | 144 | (G-2) | |
| | | (D-2) | 1% Lucirin TPO-L ® | |
| | | | (G-4) | |
| 2 I | Nanocryl | 1% Tinuvin ® | 4% Irgacure ® 500, | 1.8 |
| | xp 21/1447 | 144 | (G-2) | |
| | (AB-1) | (D-2) | 1% Lucirin TPO-L ® | |
| | | | (G-4) | |

I = According to the invention
C = Comparison

### Effect of HALS:

TABLE 4

| | | | | Taber_{(1000 cycles,500 g,CS10F wheels)} |
|---|---|---|---|---|
| Ex. | Binder resin | HALS | Photoinitiator | Δ haze (%) |
| 3 I | Nanocryl ® | 1% Tinuvin ® 144 | 4% Irgacure ® 500, | 1.8 |
| | xp21/1447 | (D-2) | (G-2) | |
| | (AB-1) | | 1% Lucirin TPO-L ® | |
| | | | (G-4) | |
| 4 C | Nanocryl ® | 1% Tinuvin ® 152 | 4% Irgacure ® 500, | 3.0 |
| | xp21/1447 | (D-4) | (G-2) | |
| | (AB-1) | | 1% Lucirin TPO-L ® | |
| | | | (G-4) | |
| 5 C | Nanocryl ® | 1% Tinuvin ® 123 | 4% Irgacure ® 500, | 3.5 |
| | xp21/1447 | (D-1) | (G-2) | |
| | (AB-1) | | 1% Lucirin TPO-L ® | |
| | | | (G-4) | |
| 6 C | Nanocryl ® | 1% Sanduvor ® | 4% Irgacure ® 500, | 3.4 |
| | xp21/1447 | 3058 | (G-2) | |
| | (AB-1) | (D-3) | 1% Lucirin TPO-L ® | |
| | | | (G-4) | |

I = According to the invention
C = Comparison

### Effect of Photoinitiator:

TABLE 5

| | | | | Taber_{(1000 cycles,500 g,CS10F wheels)} |
|---|---|---|---|---|
| Ex. | Binder resin | HALS | Photoinitiator | Δ haze (%) |
| 7 I | Nanocryl ® | 1% Tinuvin ® 144 | 4% Irgacure ® 500, | 1.8 |
| | xp21/1447 | (D-2) | (G-2) | |
| | (AB-1) | | 1% Lucirin TPO-L ® | |
| | | | (G-4) | |
| 8 C | Nanocryl ® | 1% Tinuvin ® 144 | 4% Irgacure ® 184, | 3.9 |
| | xp21/1447 | (D-2) | (G-1) | |
| | (AB-1) | | 1% Lucirin TPO-L ® | |
| | | | (G-4) | |
| 9 C | Nanocryl ® | 1% Tinuvin ® 144 | 5% Irgacure ® 1800 | 2.7 |
| | xp21/1447 | (D-2) | (G-3) | |
| | (AB-1) | | | |

I = According to the invention
C = Comparison

### Effect of Tinuvin 144 Concentration:

TABLE 6

| | | | | | Taber_{(1000 cycles,500 g,CS10F wheels)} |
|---|---|---|---|---|---|
| | | | | | Δ haze |
| Ex. | Binder resin | HALS | n (mmol) | Photoinitiator | (%) |
| 10 I | Nanocryl ® | 1% | 0.117 | 4% Irgacure ® 500 | 1.8 |
| | xp21/1447 | Tinuvin ® | | (G-2) | |
| | (AB-1) | 144 | | 1% Lucirin TPO-L ® | |
| | | (D-2) | | (G-4) | |
| 11 C | Nanocryl ® | 2% | 0.234 | 4% Irgacure ® 500 | 2.1 |
| | xp21/1447 | Tinuvin ® | | (G-2) | |
| | (AB-1) | 144 | | 1% Lucirin TPO-L ® | |
| | | (D-2) | | (G-4) | |
| 12 C | Nanocryl ® | >2% | >0.234* | 4% Irgacure ® 500 | 2.5 |
| | xp21/1447 | Tinuvin ® | | (G-2) | |
| | (AB-1) | 144 | | 1% Lucirin TPO-L ® | |
| | | (D-2) | | (G-4) | |

I = According to the invention
C = Comparison
*owing to the poor solubility of Tinuvin ® 144 beyond 2% addition, the exact content is difficult to determine since a certain proportion is undissolved, and is removed by filtration.

As shown by the tests and comparative tests, both the nanoparticles and the basic HALS system Tinuvin 144 are required with a Norrish type II photoinitiator, the surface curer containing benzophenone, in order to achieve an abrasion <2% in the Taber test using the CS10F wheels with 1000 cycles and 500 g. In particular, improved abrasion and adhesion can be achieved with a HALS concentration of 1%. It was expected that a higher HALS concentration would lead to significantly more thorough curing, since 0.488 mmol of Norrish type II photoinitiator at least theoretically requires 0.244 mmol of Tinuvin 144 in order to be able to react in an equimolar fashion (Tinuvin 144 contains two reactive amine centres). It is thus even more surprising that larger amounts of HALS evidently have a negative effect on the abrasion properties of the coating composition.

1.-16. (canceled)

17. A multilayer product comprising a first layer (S1) and a second layer (S2),
wherein the first layer is a coating composition obtained from components comprising
A) one or more aliphatic polymer precursors selected from the group consisting of components A.1, A.2, and mixtures thereof, wherein
A.1) are aliphatic oligomers that contain urethane or ester bonds and have at least two acrylate functions per molecule, or mixtures of corresponding oligomers, and
A.2) are reactive aliphatic diluents having at least two acrylate groups per molecule, or mixtures of corresponding reactive diluents,
B) one or more finely divided inorganic compounds,
C) at least one organic UV absorber comprising a triazine derivative and/or a diphenyltriazine derivative,
D) from 0.1 to 2 wt. % of a radical scavenger of the basic HALS class, expressed in terms of the experimentally determined solids content of the mixture of components A, B, and F,
E) optionally one or more levelling agents,
F) optionally one or more solvents, and
G) at least one Norrish type II photoinitiator,
and wherein the second layer is a thermoplastic polymer.

18. The multilayer product according to claim 17, wherein the first layer comprises,
expressed in terms of the mixture of components A and B:
from 20 to 95 wt. % of component A,
from 5 to 80 wt. % of component B and
from 0.1 to 10 wt. % of component G, and
an amount of component F such that an experimentally determined solids content of from 20 to 50 wt. % results for the mixture of components A, B and F, and,
expressed in terms of the solids content of the mixture of components A, B and F,
from 0.1 to 20 wt. % of component C,
from 0.1 to 2 wt. % of component D and
from 0 to 5 wt. % of component E.

19. The multilayer product according to claim 17, wherein the reactive aliphatic diluent according to component A.2 is selected from at least one of the group consisting of 1,6-hexanediol diacrylate, tricyclodecane dimethanol diacrylate, trimethyloipropane triacrylate, pentaerythritol tetraacrylate and methacrylate derivatives thereof.

20. The multilayer product according to claim 17, wherein component B is silicon dioxide with a average particle size (d₅₀ value) of from 1 to 200 nm.

21. The multilayer product according to claim 17, wherein component C is a compound according to the following Formula (IV): 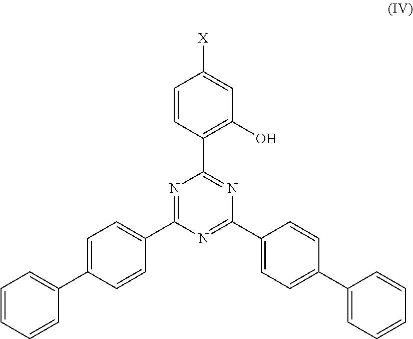
wherein
X represents OR⁶, OCH₂CH₂OR⁶, OCH₂CH(OH)CH₂OR⁶ or OCH(R⁷)COOR⁸,
R⁶ represents a branched or unbranched C₁-C₁₃ alkyl, C₂-C₂₀ alkenyl, C₆-C₁₂ aryl or —CO—C₁-C₁₈ alkyl,
R⁷ represents H or a branched or unbranched C₁-C₈ alkyl, and
R⁸ represents a C₁-C₁₂ alkyl; C₂-C₁₂ alkenyl or C₅-C₆ cycloalkyl.

22. The multilayer product according to claim 21, wherein X represents O—CH(CH₃)COO—C₈H₁₇ in Formula (IV).

23. The multilayer product according to claim 17, wherein component D is one or more compounds of the Formula (V): 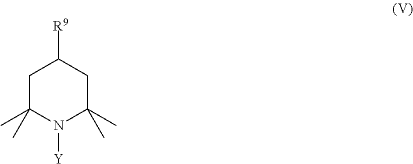
wherein
Y represents H or CH₃
R⁹ represents Z—R¹⁰—Z—R¹¹, 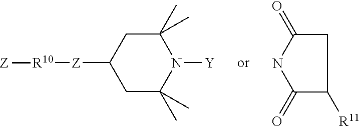
wherein
Z represents a divalent functional group such as C(O)O, NH or NHCO,
R¹⁰ represents a divalent organic residue such as (CH₂)ₗ with l=1 to 12, C═CH-Ph-OCH₃, 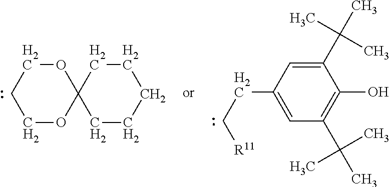
and
wherein
R¹¹ represents H or C₁-C₂₀ alkyl.

24. The multilayer product according to claim 23, wherein component D is selected from the group consisting of bis-(1,2,2,6,6-pentamethyl-4-piperidyl) (3,5-di-tert.-butyl-4-hydroxybenzyl)butylmalonate or a mixture containing bis(1,2,2,6,6-pentamethyl-4-piperidinyl)sebacate and 1-(methyl)-8-(1,2,2,6,6 pentamethyl-4-piperidinyl)sebacate.

25. The multilayer product according to claim 24, wherein component D is a compound of the Formula (D1):

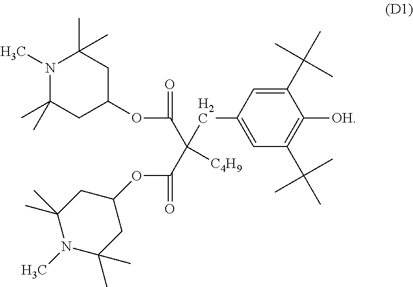

26. The multilayer product according to claim 17, wherein the coating composition components further comprise a Norrish type I photoinitiator.

27. The multilayer product according to claim 17, wherein component G is a benzophenone derivative of Formula (G1): 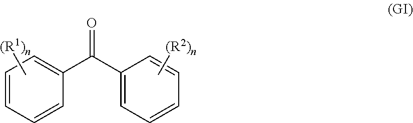
wherein
R¹ and R², independently of one another, represent a C₁-C₆ alkyl
and
n, independently of one another, represents 0, 1, 2 or 3,
or component G is a mixture of GI with a 1-hydroxycyclohexyl phenyl ketone derivative of Formula GII: 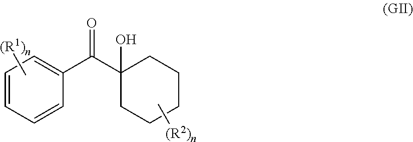
wherein
R¹ and R², independently of one another, represent a C₁-C₆ alkyl, and
n represents 0, 1, 2 or 3.

28. The multilayer product according to claim 17, wherein the second layer comprises at least one of the group consisting of polycarbonate, polyester carbonate, polyester, polyphenylene ether, graft copolymer and polyacrylate or polymethyl acrylate.

29. The multilayer product according to claim 17, wherein the multilayer product further comprises a UV protection layer (S3) which comprises a UV stabilizer according to Formula (IV): 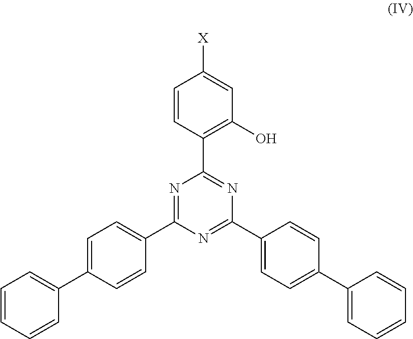
wherein
X represents OR⁶, OCH₂CH₂OR⁶, OCH₂CH(OH)CH₂OR⁶ or OCH(R⁷)COOR⁸,
R⁶ represents branched or unbranched C₁-C₁₃ alkyl, C₂-C₂₀ alkenyl, C₆-C₁₂ aryl or —CO—C₁-C₁₈ alkyl,
R⁷ represents H or branched or unbranched C₁-C₈ alkyl, and
R⁸ represents C₁-C₁₂ alkyl; C₂-C₁₂ alkenyl or C₅-C₆ cycloalkyl,
and wherein the layer sequence is (S1)-(S2)-(S3) and the layers (S1) and (S3) have identical or different compositions.

30. The multilayer product according to claim 26, wherein the Norrish type I photoinitiator is selected from at least one of the group consisting of bis(2,4,6-trimethylbenzoyl)phenylphosphine oxide, (2,4,6-trimethylbenzoyl)diphenylphosphine oxide, bis(2,6-dimethylbenzoyl), (2,4,4-trimethylpentyl)phosphine oxide, bis(2,6-dimethoxybenzoyl)(2,4,4-trimethylpentyl)phosphine oxide, bis(2,6-dimethylphenyl)benzoylphosphonate, 2,4,6-trimethylbenzoylethoxyphenylphosphine oxide, 2-benzyl-2-(dimethylamino)-1-(4-morpholinophenyl)-1-butanone and 2-methyl-1-[4-(methylthio)phenyl]-2-morpholino-1-propanone.

31. The multilayer product according to claim 17, wherein the multilayer product is an architectural glazing, motor-vehicle glazing, headlight lenses, spectacles or helmet visor.

32. A coating composition obtained from
A) one or more aliphatic polymer precursors selected from at least one of the groups consisting of the components A.1 and A.2, wherein
A.1) are aliphatic oligomers that contain urethane or ester bonds and have at least two acrylate functions per molecule, or mixtures of corresponding oligomers, and
A.2) are reactive aliphatic diluents having at least two acrylate groups per molecule, or mixtures of corresponding reactive diluents,
B) one or more finely divided inorganic compounds,
C) at least one organic UV absorber selected from the group consisting of triazine derivatives and diphenyltriazine derivatives,
D) from 0.1 to 2 wt. % of a radical scavenger of the basic HALS class, expressed in terms of the experimentally determined solids content of the mixture,
E) optionally one or more levelling agents,
F) optionally one or more solvents, and
G) at least one Norrish type II photoinitiator.
